(19) United States
(12) Patent Application Publication
(10) Pub. No.: US 2012/0140748 A1
(43) Pub. Date: Jun. 7, 2012

(54) END POINT CONTROL METHOD

(76) Inventor: John CARRUTHERS, San Clemente, CA (US)

(21) Appl. No.: 12/962,404

(22) Filed: Dec. 7, 2010

(51) Int. Cl. H04W 4/00

(52) U.S. Cl. 370/338

(57) ABSTRACT

A method is provided for enabling wireless switches to discover wireless lighting/appliance fixtures in a mesh network across layered subnets of a wireless personal area network (WPAN) via a software pairing sequence agent (PSA) incorporated within one of the wireless switches and each of the lighting/appliance fixtures.

A wireless personal area network (WPAN) generally includes one or more Access Points (APs), and several wireless client devices. Such networks work well in small office or home office (SOHO) environments where the number of APs is relatively small. As the number of

APs increases, the network becomes unwieldy and difficult to manage. To help alleviate this problem a master controller sometimes referred to as a “wireless switch” can be added to the network.

A wireless switch controls some or all of the APs in the network, and data going to or from the APs flow through the wireless switch. Large WPANs can be subdivided into multiple subnets. Subdividing a WPAN into multiple subnets has several advantages (e.g., containment of broadcast traffic to a single subnet, limiting the effect of failure of network elements to a small network segment, etc.).

The present invention provides techniques for wireless switches in a WPAN domain to discover lighting appliances and fixtures in a WPAN domain across layers and subnets.

### SUMMARY OF THE INVENTION

A method in accordance with the present invention encompasses the enablement of wireless switches in as mesh network to discover wireless lighting/appliance fixtures in the mesh network across layered subnets of a wireless personal area network (WPAN) via a software pairing sequence agent (PSA) incorporated within one of the wireless switches and each of the lighting/appliance fixtures.

The method entails using a media access control (MAC) address of the PSA switch to establish a connection between each of the lighting/appliance fixtures and the PSA switch, each lighting/appliance having a MAC address thereafter a registration message is transmitted from each wireless switch to each of the PSA lighting/appliance fixtures to register each wireless switch with the PSA wireless switch, each registration message comprising registration information associated with a corresponding wireless switch.

The method further includes updating, at each PSA lighting/appliance, a peer database for wireless switches in the mesh network with registration information received from the lighting/appliance fixtures, the registration information including a mesh network identifier of the mesh network for configuring the wireless switch in the peer database.

The PSA wireless switch is used to identify a particular lighting/appliance fixture as being a member of the mesh network and thereafter a peer discovery message is transmitted from the PSA switch to each of the wireless switches in the peer database which has registration with the PSA lighting/appliance, the peer discovery message comprising registration information associated with each new wireless switch which has registered with the PSA lighting/appliance fixtures.

Thereafter the peer database is updated at each wireless switch which receives the peer discovery method and using the registration in the peer discovery message at each lighting/appliance fixture a peering session is established with each of other wireless switches, with corresponding peer database, to exchange mesh related information to create a WPAN protocol mesh network.

More particularly, the method according to the present invention further includes joining each of the wireless switches in the mesh network with a wireless switch multi cast group and assigning, as registration information for a particular wireless switch, a MAC address/port number.

Still more particularly, the method according to the present invention further includes configuring each of the PSA lighting/appliances fixtures and wireless switches in the mesh network for enabling at a larger two while retaining a larger three MAC address.

In other words, the present invention includes activating a selected switch for a predetermined time in order to generate a pairing/discovery signal receivable by the lighting/appliance fixture, the signal being generated until the selected switch is deactivated thereafter causing at least one of the lighting/appliance fixture to assume a pairing/discovery mode by predetermined physical motion proximate the at least one of the lighting/appliance fixtures, the pairing/discovery mode being evidenced by a visual or audible signal from the at least one of the lights/appliance fixture; and thereafter, reactivating the selected switch for completing pairing/discovery in order to assign operation of the at least one of the lights/appliance fixtures to the selected switch for operating thereafter by the selected switch.

Multiple lighting/appliance switches may be caused to assume a pairing/discovery mode during generation of the pairing/discovery signal and thereafter reactivating the selected switch for completing pairing/discovery in order to assign all of the multiple lights/appliances fixtures to the selected switch for operation by the selected switch.

### DETAILED DESCRIPTION

In one implementation of the present invention each of wireless switches in a WPAN domain can join a lighting appliances and fixtures Group. A first wireless switch in the WPAN domain can transmit a report message addressed to lighting appliances and fixtures in the WPAN domain to indicate presence of the first wireless switch in the WPAN domain. The lighting appliances and fixtures can use information in the report message sent from the first wireless switch to establish a WPAN peering session with the first wireless switch.

In another implementation of the present invention, a software pairing sequence agent wireless switch can be employed to allow wireless switches in a WPAN domain to discover lighting appliances and fixtures in the WPAN domain.

Each of the wireless switches in the WPAN domain can use a Media Access Control (MAC) address of the software pairing sequence agent wireless switch to establish a connection from each of the lighting appliances and fixtures to the software pairing sequence agent wireless switch, and transmit a registration message from each of the lighting appliances and fixtures to the software pairing sequence agent wireless switch to register with the software pairing sequence agent lighting appliances and fixtures. Each registration message comprises registration information associated with the particular lighting appliances and fixtures that transmitted a particular registration message.

Upon receiving a registration message, the software pairing sequence agent wireless switch updates its peer database for lighting appliances and fixtures in the WPAN domain with registration information received from the wireless switches.

The software pairing sequence agent wireless switch can then transmit a peer discovery message to each of the lighting appliances and fixtures in the peer database which have registered with the software pairing sequence agent wireless switch. The peer discovery message comprises registration information associated with each new lighting appliances and fixtures in WPAN domain, which has registered with the software pairing sequence agent wireless switch. Each wireless switch which receives the peer discovery message can update its peer database, and use the registration information in the peer discovery message to establish a peering session with each of the lighting appliances and fixtures in their respective peer database as a client to the home lighting appliances and fixtures.

As an example the method for assigning a single lighting appliance in accordance with the present invention may be accomplished by depressing and holding a button on the wireless switch for a predetermined period of time.

This activates a pairing/discovery signal to be emitted from the wireless switch and that signal will continue until the button is depressed a second time.

In the meantime, pairing of a lighting appliance with the wireless switch is effected through predetermined motion/motions at the lighting appliance which will cause the lighting appliance to go into pairing/discovery mode. Such motion may be, for example, by body movement. Acknowledgement of the appliance being ready to paired may be a blinking of an appliance light or an audible sound. At such time a user will go over to the wireless light switch and depress the button for a second time completing the pairing/discovery. At this point the lighting appliance is assigned to that button.

For assigning multiple lighting appliances to a single button “wireless scene configuration” a button is depressed and held on the wireless switch for a predetermined period of time. This activates a pairing/discovery signal to be emitted from the wireless switch and that signal will continue until the button is depressed a second time.

In the meantime to allow lighting appliances to be paired/discovered with the wireless switch will be activated by a predetermined motion/motions at the lighting appliance as hereinabove described, which will cause the lighting appliance to go into pairing/discovery mode. A visual or audio identification is given ,as noted hereinabove, including the appliance is ready to be paired. At such time the user can go to another lighting appliance and activate that lighting appliance with the same predetermined motion/motions, the user can continue this process without limit to how many lighting appliances can be assigned to an individual button on the wireless wall switch. Subsequently, the user will go over to the wireless light switch and depress the button for a second time completing the pairing/discovery of all the lighting appliances that were paired/discovered. At this point the lighting appliances are assigned to that button.

It should be appreciated that there are no limits to the amount of buttons on a wireless wall switch; these will be confined by the physical layout and design of the wireless wall switch itself. Wireless wall switches can be gang mounted to allow for unlimited wireless switches, unlimited buttons and unlimited lighting appliance configurations.

The method of changing a configuration of a button on a wireless wall switch is accomplished by depressing the button for a pre-determined period of time. When the button is in pairing/discovery mode the prior light appliance configuration will be deleted and the new configuration can now be pair/discovered and assigned.

Although there has been hereinabove described a specific end point control method for lighting in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A method for enabling wireless switches to discover wireless lighting/appliance fixtures in a mesh network across layered subnets of a wireless personal area network (WPAN) via a software pairing sequence agent (PSA) incorporated within one of the wireless switches and each of the lighting/appliance fixtures, the method comprising:
using a media access control (MAC) address of the PSA switch to establish a connection between each of the lighting/appliance fixtures and the PSA switch, each lighting/appliance having a MAC address;
transmitting a registration message from each wireless switch to each of the PSA lighting/appliance fixtures to register each wireless switch with the PSA wireless switch, each registration message comprises registration information associated with a corresponding wireless switch;
updating, at each PSA lighting/appliance, a peer database for wireless switches in the mesh network with registration information received from the lighting/appliance fixtures, the registration information including a mesh network identifier of the mesh network for configuring the wireless switch in the peer database;
using the PSA wireless switch to identify a particular lighting/appliance fixture as being a member of the mesh network;
transmitting, from the PSA switch, a peer discovery message to each of the wireless switches in the peer database which have registration with the PSA lighting/appliance, the peer discovery message comprising registration information associated with each new wireless switch which has registered with the PSA lighting/appliance fixtures;
updating the peer database at each wireless switch which receives the peer discovery method; and
using the registration in the peer discovery message at each lighting/appliance fixture to establish a peering session with each of other wireless switches, with corresponding peer database, to exchange mesh related information to create a WPAN protocol mesh network.

2. The method according to claim 1 further comprises joining each of the wireless switches in the mesh network with a wireless switch multicast group.

3. The method according to claim 1 further comprising assigning, as registration information for a particular wireless switch, a MAC address/port number.

4. The method according to claim 1 further comprising configuring each of the PSA lighting/appliances fixtures and wireless switches for enabling on of the lighting/appliance to roam within the mesh network at a layer two while retaining a larger three MAC address.

5. A method for enabling wireless switches to discover wireless lighting/appliance fixtures in a mesh network across layered subnets of a wireless personal area network (WPAN) via a software pairing sequence agent (PSA) incorporated within one of the wireless switches and each of the lighting/appliance fixtures, the method comprising:
activating a selected switch for a predetermined time in order to generate a pairing/discovery signal receivable by the lighting/appliance fixture, the signal being generated until the selected switch is deactivated thereafter;
causing at least one of the lighting/appliance fixture to assume a pairing/discovery mode by predetermined physical motion proximate the at least one of the lighting/appliance fixtures, the pairing/discovery mode being evidenced by a visual or audible signal from the at least one of the lights/appliance fixture and thereafter;
reactivating the selected switch for completing pairing/discovery in order to assign operation of the at least one of the lights/appliance fixtures to the selected switch for operating thereafter by the selected switch.

6. The method according to claim 5 wherein multiple lighting/appliance switches are caused to assume a pairing/discovery mode during generation of the pairing/discovery signal and thereafter reactivating the selected switch for completing pairing/discovery in order to assign all of the multiple lights/appliances fixtures to the selected switch for operation by the selected switch.
